(19) United States
(12) Patent Application Publication
(10) Pub. No.: US 2025/0386224 A1
(43) Pub. Date: Dec. 18, 2025

(54) AI/ML MODEL IDENTIFIER ACQUISITION FOR AI/ML-BASED MODEL CONFIGURATION

(71) Applicant: Lenovo (Singapore) Pte Ltd, Singapore (SG)

(72) Inventors: Ahmed Hindy, Aurora, IL (US); Vahid Pourahmadi, München (DE); Vijay Nangia, Woodridge, IL (US); Venkata Srinivas Kothapalli, Ottawa (CA)

(73) Assignee: Lenovo (Singapore) Pte Ltd, Singapore (SG)

(21) Appl. No.: 18/746,995

(22) Filed: Jun. 18, 2024

(51) Int. Cl. H04W 24/10; G06N 20/00; H04L 41/16

(52) U.S. Cl. CPC H04W 24/10; G06N 20/00; H04L 41/16

(57) ABSTRACT

Various aspects of the present disclosure relate to AI/ML model identifier acquisition for AI/ML-based model configuration. An apparatus, such as a UE, receives, from a network entity, an artificial intelligence (AI)-based configuration corresponding to signal transmission and/or signal reception by the UE, where the AI-based configuration is associated with one or more AI models, and an AI model is associated with a dataset. The UE receives, from the network entity, a reference signal configuration for a set of reference signals, and the reference signal configuration is paired with the AI-based configuration. The UE measures a set of report parameters based at least in part on the set of reference signals. The UE transmits, to the network entity, a feedback report comprising the set of report parameters, and the feedback report is usable by the network entity to select the AI model from the one or more AI models.

### TECHNICAL FIELD

The present disclosure relates to wireless communications, and more specifically to AI/ML model identification techniques for network entity and user equipment (UE) coordination.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling. Artificial intelligence and machine learning (AI/ML) may be utilized in new radio (NR) networks, such as to facilitate techniques for channel state information (CSI) estimation and feedback, beam management (BM) enhancements, positioning enhancements, and/or mobility enhancements. In different configurations, AI/ML models may be one-sided (i.e., deployed and trained at either the network side or the UE side), or two-sided (i.e., an AI/ML the model has two parts, each trained and deployed at the different network and UE sides). In either case, the network may need to indicate to a UE that a transmission and/or reception configuration has changed, including switching from one AI/ML model to another, to enable ubiquitous communication without causing detection errors, decoding failures, or degraded performance.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a UE for wireless communication to receive, from a network entity, an artificial intelligence (AI)-based configuration corresponding to at least one of signal transmission or signal reception by the UE, the AI-based configuration associated with one or more AI models, an AI model associated with a dataset. The UE receives, from the network entity, a reference signal configuration for a set of reference signals, the reference signal configuration paired with the AI-based configuration. The UE measures a set of report parameters based at least in part on the set of reference signals. The UE transmits, to the network entity, a feedback report comprising the set of report parameters, the feedback report usable by the network entity to select the AI model from the one or more AI models.

In some implementations of the method and apparatuses described herein, the one or more AI models are trained at least in part at the UE. The UE measures channel properties based at least in part on the set of reference signals received at the UE, the channel properties including at least one of a delay-dependent property, a Doppler-dependent property, or a spatial correlation property, and selection of the AI model from the one or more AI models is based on the channel properties. The UE receives an additional set of reference signals subsequent to receiving the set of reference signals, and a measurement on the additional set of reference signals is an input to the AI model of the one or more AI models. The one or more AI models are trained at the network entity. Selection of the AI model from the one or more AI models is based on the set of report parameters in the feedback report transmitted to the network entity. The set of report parameters in the feedback report include one or more of a time-domain channel property (TDCP) parameter, a time synchronization parameter, a delay synchronization parameter, a frequency synchronization parameter, a Doppler synchronization parameter, a phase synchronization parameter, or a set of approximate values of a set of condition parameters based on the set of reference signals.

Additionally, the UE transmits, to the network entity, an additional feedback report subsequent to transmitting the feedback report, the additional feedback report comprising input parameters that are usable as input to the AI model of the one or more AI models. The input parameters in the additional feedback report include one or more of an indication of a configuration identifier (ID) associated with one of the set of reference signals, the feedback report, the AI model, or a set of label values associated with the dataset corresponding to the AI model in the one or more AI models. The reference signal configuration corresponds to a CSI-based configuration. At least one of an identification of the AI model in the one or more AI models is signaled from the UE to the network entity, or the identification of the AI model in the one or more AI models is signaled from the network entity to the UE. The identification of the AI model is based on one or more of a sequence of label values of a training dataset associated with training of the AI model, an ID of at least one of a CSI report setting, a CSI resource setting, a transmission configuration indicator (TCI) state, a transmission mode reported in one of downlink control information (DCI), uplink control information (UCI), a medium access control (MAC) control element (MAC-CE), a radio resource control (RRC) signal, or a zero-power (ZP) reference signal, wherein the ZP reference signal is quasi-co-located with at least one reference signal in the set of reference signals according to one or more quasi-co-location (QCL) properties.

Additionally, selection of the AI model from the one or more AI models is based at least in part on an AI model monitoring procedure, the AI model monitoring procedure comprising a measurement phase, an evaluation phase, and a monitoring output phase. The measurement phase corresponds to signaling of a monitoring report comprising a set of performance monitoring parameters measured at the UE or at the network entity. The monitoring report is one of received by the UE as a downlink MAC-CE or as a DCI signal, or transmitted by the UE as an uplink MAC-CE or as an UCI signal. The evaluation phase comprises a comparison of a first performance of a first AI model with a second performance of a baseline AI model, the comparison based at least in part on the set of performance monitoring parameters; and the second performance of the baseline AI model corresponds to at least one of a performance of a second AI model, the first performance of the first AI model at a prior time interval compared with another time interval of the first performance of the first AI model, or a fixed set or a pre-configured set of performance monitoring parameter values. The monitoring output phase comprises at least one of a recommended AI model selection indication provided by the UE, or an AI model selection command provided by the network entity; and the recommended AI model selection indication is at least one of an ID of the AI model, a set of label values corresponding to a training dataset corresponding to a trained AI model, a TCI state, correlation information, or a QCL relationship.

Some implementations of the method and apparatuses described herein may further include a processor for wireless communication to receive, from a network entity, an AI-based configuration corresponding to at least one of signal transmission or signal reception, the AI-based configuration associated with one or more AI models, an AI model associated with a dataset. The processor receives, from the network entity, a reference signal configuration for a set of reference signals, the reference signal configuration paired with the AI-based configuration. The processor measures a set of report parameters based at least in part on the set of reference signals. The processor transmits, to the network entity, a feedback report comprising the set of report parameters, the feedback report usable by the network entity to select the AI model from the one or more AI models.

Some implementations of the method and apparatuses described herein may further include a method performed by a UE, the method including receiving, from a network entity, an AI-based configuration corresponding to at least one of signal transmission or signal reception by the UE, the AI-based configuration associated with one or more AI models, an AI model associated with a dataset; receiving, from the network entity, a reference signal configuration for a set of reference signals, the reference signal configuration paired with the AI-based configuration; measuring a set of report parameters based at least in part on the set of reference signals; and transmitting, to the network entity, a feedback report comprising the set of report parameters, the feedback report usable by the network entity to select the AI model from the one or more AI models.

Some implementations of the method and apparatuses described herein may further include a network entity for wireless communication to transmit, to a UE, an AI-based configuration corresponding to at least one of signal transmission or signal reception by the UE, the AI-based configuration associated with one or more AI models, an AI model associated with a dataset. The network entity transmits, to the UE, a reference signal configuration for a set of reference signals, the reference signal configuration paired with the AI-based configuration. The network entity receives, from the UE, a feedback report comprising a set of report parameters. The network entity selects the AI model based at least in part on the set of report parameters.

### BRIEF DESCRIPTION OF THE DRAWINGS

FIG. 1 illustrates an example of a wireless communications system in accordance with aspects of the present disclosure.

FIG. 2 illustrates an example of aperiodic trigger state defining a list of CSI report settings, in accordance with aspects of the present disclosure.

FIG. 3 illustrates an example of aperiodic trigger state that indicates the resource set and QCL information, in accordance with aspects of the present disclosure.

FIG. 4 illustrates an example of a radio resource control (RRC) configuration for a non-zero power (NZP) CSI-reference signal (RS) resource and a CSI-interference management (IM) resource, in accordance with aspects of the present disclosure.

FIG. 5 illustrates an example of a partial CSI omission for physical uplink shared channel (PUSCH)-based CSI, in accordance with aspects of the present disclosure.

FIG. 6 illustrates an example of ASN-1 code for configuring an NZP-CSI-RS resource set, in accordance with aspects of the present disclosure.

FIG. 7 illustrates an example of tracking reference signal (TRS) configuration, in accordance with aspects of the present disclosure.

FIG. 8 illustrates an example of ASN-1 code for QCL information, in accordance with aspects of the present disclosure.

FIG. 9 illustrates an example of ASN-1 code for physical downlink shared channel (PDSCH)-Config information element (IE), in accordance with aspects of the present disclosure.

FIG. 10 illustrates an example of ASN-1 code for demodulation reference signal (DMRS)-DownlinkConfig, in accordance with aspects of the present disclosure.

FIGS. 11A and 11B illustrate an example of DMRS patterns for mapping Type A with front-load DMRS, in accordance with aspects of the present disclosure.

FIG. 12 illustrates an example of a UE in accordance with aspects of the present disclosure.

FIG. 13 illustrates an example of a processor in accordance with aspects of the present disclosure.

FIG. 14 illustrates an example of a NE in accordance with aspects of the present disclosure.

FIG. 15 illustrates a flowchart of a method performed by a UE in accordance with aspects of the present disclosure.

FIG. 16 illustrates a flowchart of a method performed by a NE in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. In implementations, AI/ML models may be utilized in NR networks, such as to facilitate techniques for CSI estimation and feedback, BM enhancements, positioning enhancements, and/or mobility enhancements. In different configurations, AI/ML models may be one-sided (i.e., deployed and trained at either the network side or the UE side), or two-sided (i.e., an AI/ML the model has two parts, each trained and deployed at the different network and UE sides). In either case, the network may need to indicate to a UE that a transmission and/or reception configuration has changed, including switching from one AI/ML model to another, to enable ubiquitous communication without causing detection errors, decoding failures, or degraded performance. Each side (e.g., network side and UE side) of the wireless communications system may have a set of pre-trained AI/ML models, depending on whether the AI/ML model(s) are one-sided or two-sided. While the model input and the model output at one side may be standardized or coordinated across different devices and/or entities in a network, the model design details, as well as the number of AI/ML models at each side, may be kept private per UE and/or network vendor.

With reference to ID-based model switching and life cycle management (LCM), both the network and UE side communicate a set of model description parameters that may include an ID of an AI/ML model, a transmission and/or reception configuration associated with the model, as well as a set of model description parameters that characterize the AI/ML model. However, the ID-based model switching framework may require substantial coordination between vendors at both the network side and the UE side, during both the rollout phase of an AI/ML model for a certain procedure, as well as for subsequent maintenance and/or upgrades to this framework.

With reference to functionality-based model switching and LCM, for two-sided models or UE-based one-sided models, the UE reports monitoring information corresponding to some model activation, deactivation, switching, and fallback, which is characterized via a model functionality. The model functionality corresponds to a UE feature (i.e., each model corresponds to a set of UE features, where each model is characterized by these features). However, conventionally, there is no clear emphasis on how the functionality identification and/or signaling can be specified, and whether or how the functionalities would correspond to conditions or additional conditions associated with the environment or configuration of the AI/ML model.

Aspects of the present disclosure support using one or more AI/ML models or algorithms (e.g., a neural network, AI algorithms). For example, a UE and/or network entity may include an AI/ML model or algorithm, a neural network, and/or any other type of machine learning model to implement the described techniques. In implementations, a network entity may be any node (e.g., base station, gNB, network component, network equipment (NE), logical node) in a wireless communications system, and may be a physical and/or logical implementation (e.g., distributed across multiple network entities and/or devices). As used herein, AI and/or a machine learning model refers to a computer representation that is trainable based on inputs to approximate unknown functions. For example, a machine learning model can utilize algorithms to learn from, and make predictions on, inputs of known data (e.g., training and/or reference data) by analyzing the known data to learn to generate outputs. In aspects of the present disclosure, characteristics, datasets, parameters, and/or values corresponding to AI/ML models may be measured and/or determined to identify an AI/ML model in a wireless communications system. Additionally, reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Given multiple AI/ML models in a wireless communications system at each of the network side (e.g., network entity) and the UE side of the communications, and the AI/ML models corresponding to different channel and/or transmission conditions, a robust framework for model switching is needed, and model switching that is independent of a public model ID known at both sides, which can be described as functionality-based model switching. In order to achieve the AI/ML model switching and indications, a QCL-based relationship between the different models, or alternatively between different datasets associated with the models, can be implemented to facilitate the model switching. Moreover, an RS transmission and measurement phase may precede a model monitoring decision and/or recommendation that enables model switching based on the model functionality, or model features.

Aspects of the present disclosure are described in the context of a wireless communications system, and include implementations that provide for robust AI/ML configuration across different network vendors and UE vendors, without the need for substantial coordination on the AI/ML model structure and organization. The described techniques include an RS transmission and measurement phase that precedes a model monitoring decision and/or recommendation to enable AI/ML model switching based on the model functionality, or the AI/ML model features. The described techniques also include signaling implementations to convey model switching, as well as transmission and/or reception configuration, between the network side and the UE side for proper coordination between both sides of the communications network, given the environment and configuration changes.

Aspects of the present disclosure are described in the context of a wireless communications system.

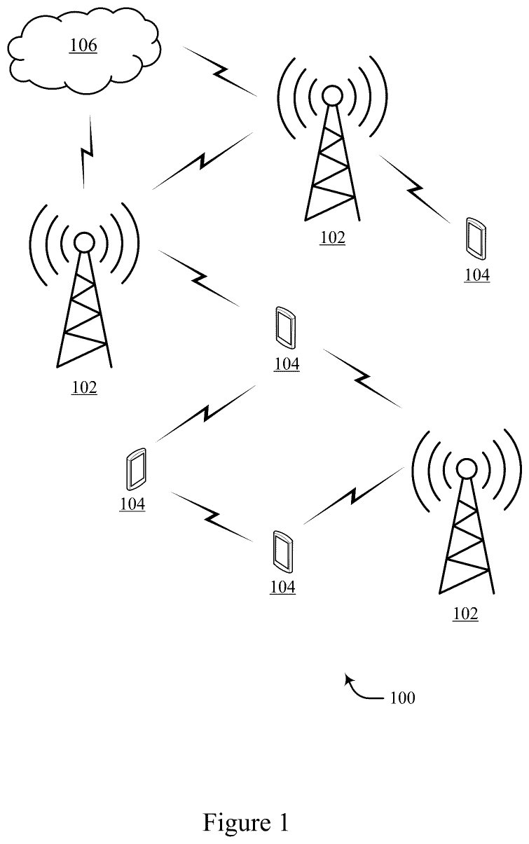

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives, from a NE 102 (e.g., a network entity), an AI-based configuration corresponding to signal transmission and/or signal reception by the UE. The AI-based configuration is associated with one or more AI models, and an AI model is associated with a dataset. The UE 104 also receives, from the NE, a reference signal configuration for a set of reference signals, where the reference signal configuration is paired with the AI-based configuration. The UE 104 measures a set of report parameters based on the set of reference signals, and transmits, to the NE, a feedback report comprising the set of report parameters. The feedback report is usable by the NE to select the AI model from the one or more AI models. Similarly, the NE 102 (e.g., a network entity) transmits, to the UE 104, the AI-based configuration corresponding to the signal transmission and/or signal reception by the UE. The AI-based configuration is associated with one or more AI models, and an AI model is associated with a dataset. The NE 102 also transmits, to the UE 104, a reference signal configuration for a set of reference signals, where the reference signal configuration is paired with the AI-based configuration. The NE 102 receives, from the UE 104, a feedback report comprising a set of report parameters, and the NE selects the AI model based at least in part on the set of report parameters. Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

With reference to ID-based model switching and LCM, both the network and UE side communicate a set of model description parameters that may include an ID of an AI/ML model, a transmission and/or reception configuration associated with the model, as well as a set of model description parameters that characterize the AI/ML model. However, the ID-based model switching framework may require substantial coordination between vendors at both the network side and the UE side, during both the rollout phase of an AI/ML model for a certain procedure, as well as for subsequent maintenance and/or upgrades to this framework.

With reference to functionality-based model switching and LCM, for two-sided models or UE-based one-sided models, the UE reports monitoring information corresponding to some model activation, deactivation, switching, and fallback, which is characterized via a model functionality. The model functionality corresponds to a UE feature (i.e., each model corresponds to a set of UE features, where each model is characterized by these features). However, conventionally, there is no clear emphasis on how the functionality identification and/or signaling can be specified, and whether or how the functionalities would correspond to conditions or additional conditions associated with the environment or configuration of the AI/ML model.

With reference to CSI reporting, the codebook report is partitioned into two parts based on the priority of information reported. Each part is encoded separately (Part 1 has a possibly higher code rate). Below, only the parameters for NR Rel. 16 Type-II codebook are listed. With reference to the content of a CSI report, a Part 1 is rank indicator (RI)+channel quality indicator (CQI)+total number of coefficients. A Part 2 is a spatial domain (SD) basis indicator+frequency domain (FD) basis indicator/layer+bitmap/layer+coefficient amplitude info/layer+coefficient phase info/layer+strongest coefficient indicator/layer. Furthermore, Part 2 CSI can be decomposed into sub-parts, each with different priority (higher priority information listed first). Such partitioning is required to allow dynamic reporting size for a codebook based on available resources in the uplink (UL) phase. Additionally, Type-II codebook is based on aperiodic CSI reporting, and only reported in physical uplink shared channel (PUSCH) via DCI triggering (one exception). Type-I codebook can be based on periodic CSI reporting (physical uplink control channel (PUCCH)) or semi-persistent CSI reporting (PUSCH or PUCCH) or aperiodic reporting (PUSCH).

With reference to triggering aperiodic CSI reporting on PUSCH, a UE needs to report the needed CSI information for the network using the CSI framework in NR (Rel. 15). The triggering mechanism between a report setting and a resource setting is summarized in Table 1.

TABLE 1
Triggering mechanism between a report
setting and a resource setting.

| | | Periodic CSI | SP CSI | AP CSI |
|---|---|---|---|---|
| | | reporting | reporting | Reporting |
| Time | Periodic | RRC | MAC CE (PUCCH) | DCI |
| Domain | CSI-RS | configured | DCI (PUSCH) | |
| Behavior of | SP | Not | MAC CE (PUCCH) | DCI |
| Resource | CSI-RS | Supported | DCI (PUSCH) | |
| Setting | AP | Not | Not Supported | DCI |
| | CSI-RS | Supported | | |

Moreover, all associated resource settings for a CSI report setting need to have the same time domain behavior. Periodic CSI-RS/IM resource and CSI reports are assumed to be present and active once configured by RRC. Aperiodic and semi-persistent CSI-RS/IM resources and CSI reports are explicitly triggered or activated. For aperiodic CSI-RS/IM resources and aperiodic CSI reports, the triggering is performed jointly by transmitting a DCI format 0-1. Semi-persistent CSI-RS/IM resources and semi-persistent CSI reports are independently activated.

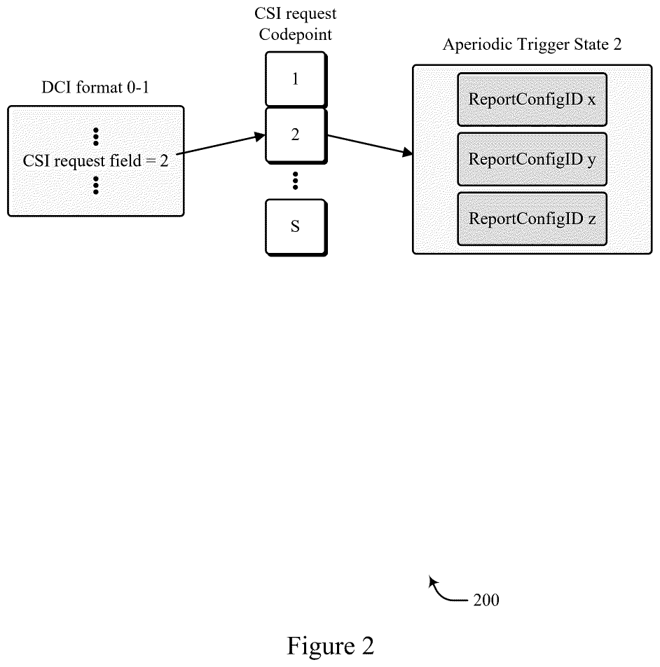

FIG. 2 illustrates an example 200 of aperiodic trigger state defining a list of CSI report settings, in accordance with aspects of the present disclosure. In this example 200, for aperiodic CSI-RS/IM resources and aperiodic CSI reports, the triggering is performed jointly by transmitting a DCI format 0-1. The DCI format 0_1 contains a CSI request field (0 to 6 bits). A non-zero request field points to an aperiodic trigger state configured by RRC. An aperiodic trigger state in turn is defined as a list of up to sixteen (16) aperiodic CSI report settings, identified by a CSI report setting ID for which the UE calculates simultaneously CSI and transmits it on the scheduled PUSCH transmission.

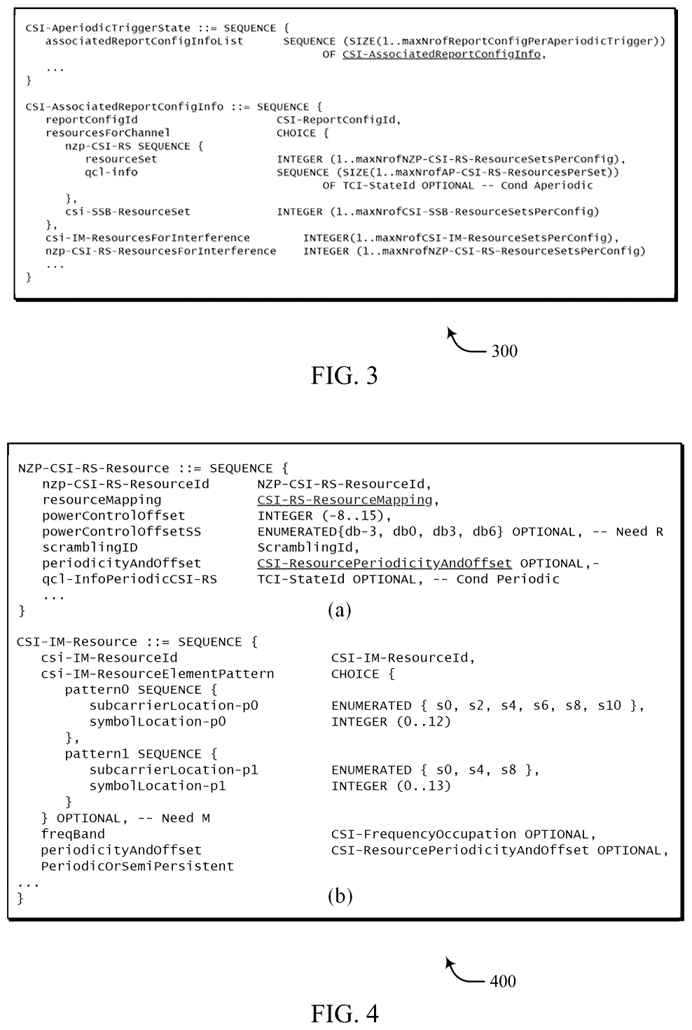

FIG. 3 illustrates an example 300 of an aperiodic trigger state that indicates the resource set and QCL information, in accordance with aspects of the present disclosure. This example 300 indicates that when the CSI report setting is linked with an aperiodic resource setting (which may include multiple resource sets), the aperiodic NZP CSI-RS resource set for channel measurement, the aperiodic CSI-IM resource set (if used), and the aperiodic NZP CSI-RS resource set for IM (if used) to use for a given CSI report setting are also included in the aperiodic trigger state definition, as shown in this example 300. For aperiodic NZP CSI-RS, the QCL source to use is also configured in the aperiodic trigger state. The UE assumes that the resources used for the computation of the channel and interference can be processed with the same spatial filter (i.e. quasi-co-located with respect to QCL-TypeD).

FIG. 4 illustrates an example 400 of a RRC configuration for (a) an NZP-CSI-RS resource and (b) CSI-IM resource, in accordance with aspects of the present disclosure. This example 400 indicates the RRC configuration for (a) NZP-CSI-RS resources and (b) CSI-IM resources.

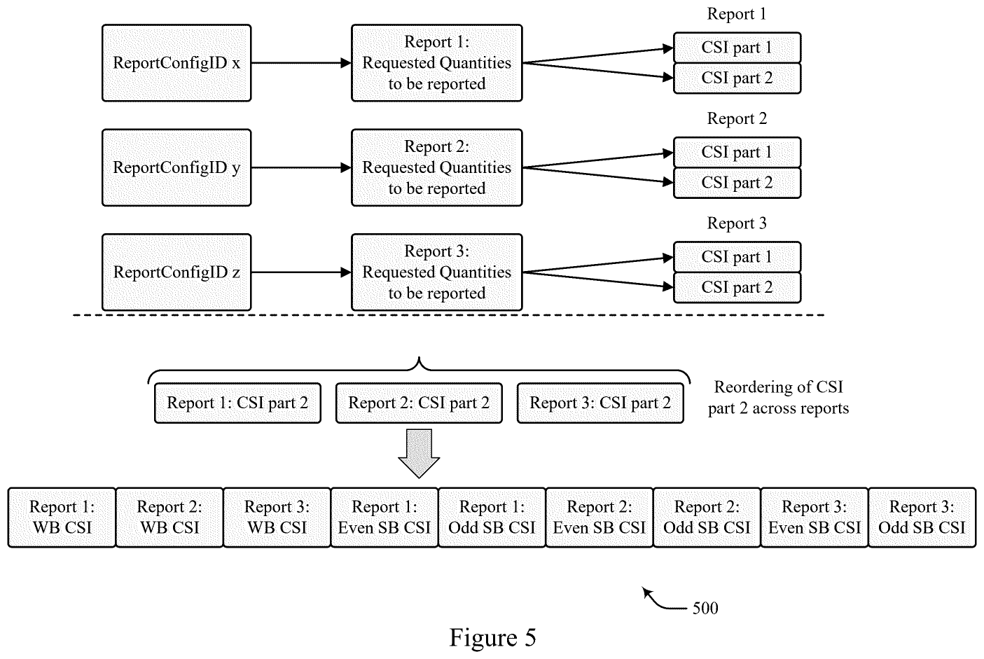

FIG. 5 illustrates an example 500 of a partial CSI omission for PUSCH-based CSI, in accordance with aspects of the present disclosure. For aperiodic CSI reporting, PUSCH-based reports are divided into two CSI parts, CSI Part 1 and CSI Part 2, because the size of CSI payload varies significantly, and therefore a worst-case UCI payload size design would result in large overhead. CSI Part 1 has a fixed payload size (and can be decoded by the gNB without prior information) and contains RI (if reported), a CSI-RS resource index (CRI) (if reported), and CQI for the first codeword, as well as a number of non-zero wideband amplitude coefficients per layer for Type II CSI feedback on PUSCH. CSI Part 2 has a variable payload size that can be derived from the CSI parameters in CSI Part 1 and contains precoder matrix indicator (PMI) and the CQI for the second codeword when RI>4. For example, if the aperiodic trigger state indicated by DCI format 0_1 defines 3 report settings x, y, and z, then the aperiodic CSI reporting for CSI part 2 will be ordered as indicated in this example 500.

As described, CSI reports are prioritized according to several factors, including the time-domain behavior and physical channel, where more dynamic reports are given precedence over less dynamic reports and PUSCH has precedence over PUCCH; CSI content, where beam reports (i.e., L1-reference signal received power (RSRP) reporting) has priority over regular CSI reports; the serving cell to which the CSI corresponds (in case of carrier aggregation (CA) operation), and CSI corresponding to the PCell has priority over CSI corresponding to Scells; and the reportConfigID.

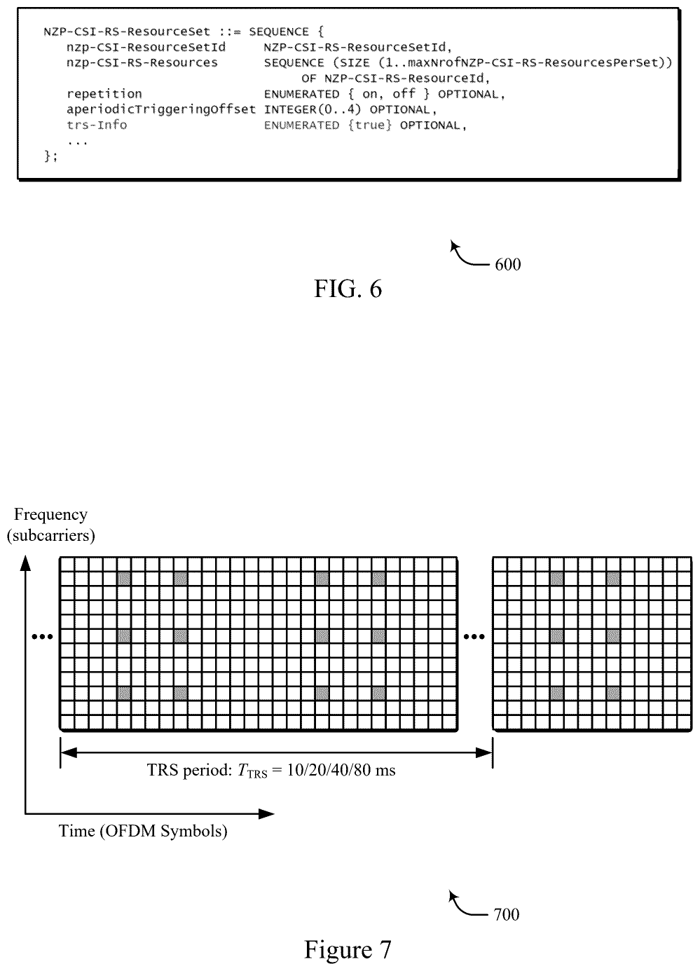

FIG. 6 illustrates an example 600 of ASN-1 code for configuring an NZP-CSI-RS resource set, in accordance with aspects of the present disclosure. Aspects are directed to TRS, which is transmitted for establishing fine time and frequency synchronization at a UE to aid in demodulation of PDSCH, particularly for higher order modulations. A TRS is an NZP CSI-RS resource set with “TRS-info” set to true. As shown in the example 600, “trs-info” indicates that the antenna port for all NZP-CSI-RS resources in the CSI-RS resource set is the same. The TRS contains either two or four periodic CSI-RS resources with periodicity 2^{-μ}*Xp slots where Xp=10, 20, 40, or 80 and where μ is related to the sub carrier spacing (SCS), i.e. μ=0, 1, 2, 3, 4 for 15, 30, 60, 120, 240 kHz, respectively. The slot offsets for the 2 or 4 CSI-RS resources are configured such that the first pair of resources are transmitted in one slot, and the 2nd pair (if configured) are transmitted in the next (adjacent) slot. All four resources are single port with density 3, as further shown in FIG. 7.

FIG. 7 illustrates an example 700 of TRS configuration, in accordance with aspects of the present disclosure. In this example 700, the two CSI-RS within a slot are always separated by four symbols in the time domain. This time-domain separation sets a limit for the maximum frequency error that can be compensated. Likewise, the frequency-domain separation of four subcarriers sets a limit for the maximum timing error that can be compensated. The maximum number of TRS a UE can be configured with is a UE capability. For example, the maximum number of TRS resource sets (per component carrier (CC)) that a UE is able to track simultaneously: Candidate value set {1 to 8}. The maximum number of TRS resource sets configured to UE per CC: Candidate value set: {1 to 64}. The UE is mandated to report at least eight for FR1 and sixteen for FR2. The maximum number of TRS resource sets configured to UE across CCs: Candidate value set: {1 to 256}. UE is mandated to report at least sixteen for FR1 and thirty-two for FR2. Furthermore, an aperiodic TRS is a set of aperiodic CSI-RS for tracking that is optionally configured, but a periodic TRS always needs to be configured, and its time and frequency domain configurations (except for the periodicity) must match those of the periodic TRS. The UE may assume that the aperiodic TRS resources are quasi-co-located with the periodic TRS resources.

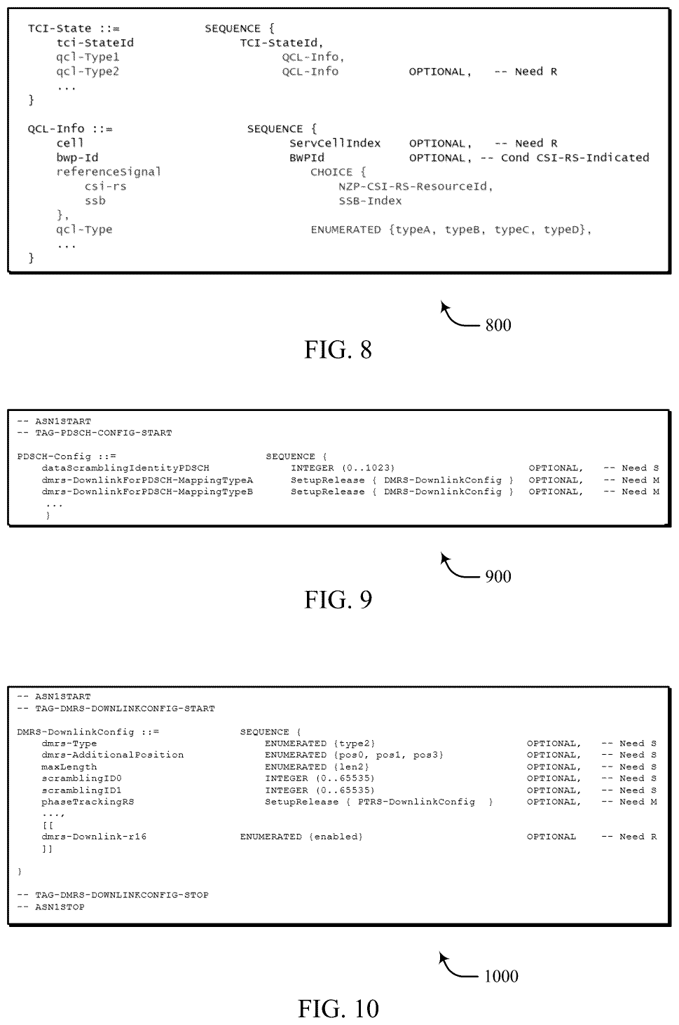

FIG. 8 illustrates an example 800 of ASN-1 code for QCL information, in accordance with aspects of the present disclosure. In this example 800, a TCI state (in example 800 and as configured by RRC) will have two QCL types (i.e., two reference signals) with the second QCL type only for operation in FR2.

With reference to DMRS and reception of DMRS for PDSCH, QCL TypeA properties (Doppler shift, Doppler spread, average delay, delay spread) can be inferred from a periodic TRS. In turn for periodic TRS, QCL TypeC properties (Average delay, Doppler shift) can be inferred from a synchronization signal block (SSB). The DMRS is used to estimate channel coefficients for coherent detection of the physical channels. For downlink, the DMRS is subject to the same precoding as the PDSCH. NR first defines two time-domain structures for DMRS according to the location of the first DMRS symbol. For example, mapping Type A, where the first DMRS is located in the second and the third symbol of the slot, and the DMRS is mapped relative to the start of the slot boundary, regardless of where in the slot the actual data transmission occurs. Further, mapping Type B, where the first DMRS is positioned in the first symbol of the data allocation, that is, the DMRS location is not given relative to the slot boundary, rather relative to where the data are located.

The mapping of PDSCH transmission can be dynamically signaled as part of the DCI. Moreover, the DMRS has two types, Types 1 and 2, which are distinguished in frequency-domain mapping and the maximum number of orthogonal reference signals. Type 1 can provide up to four orthogonal signals using a single-symbol DMRS and up to eight orthogonal reference signals using a double-symbol DMRS. For four orthogonal signals, ports 1000 and 1001 use even-numbered subcarriers and are separated in the code domain within the code division multiplexing (CDM) group (length-2 orthogonal sequences in the frequency domain). Antenna ports 1000 and 1001 belong to CDM group 0, since they use the same subcarriers. Similarly, ports 1002 and 1003 belong to CDM group 1 and are generated in the same way using odd-numbered subcarriers. The DMRS Type 2 has a similar structure to Type 1, but Type 2 can provide 6 and 12 patterns depending on the number of symbols. Four subcarriers are used in each resource block and in each CDM group defining three CDM groups.

FIG. 9 illustrates an example 900 of ASN-1 code for PDSCH-Config IE, in accordance with aspects of the present disclosure. In this example 900, the configuration of the DMRS Type is provided through higher-layer signaling independently for each PDSCH and PUSCH, each mapping Type (A or B), and each bandwidth part (BWP) independently (see the RRC configuration). The PDSCH-Config IE, as shown in example 900, is used to configure the UE specific PDSCH parameters.

FIG. 10 illustrates an example 1000 of ASN-1 code for DMRS-DownlinkConfig, in accordance with aspects of the present disclosure. In this example 1000, the IE DMRS-DownlinkConfig is used to configure downlink demodulation reference signals for PDSCH.

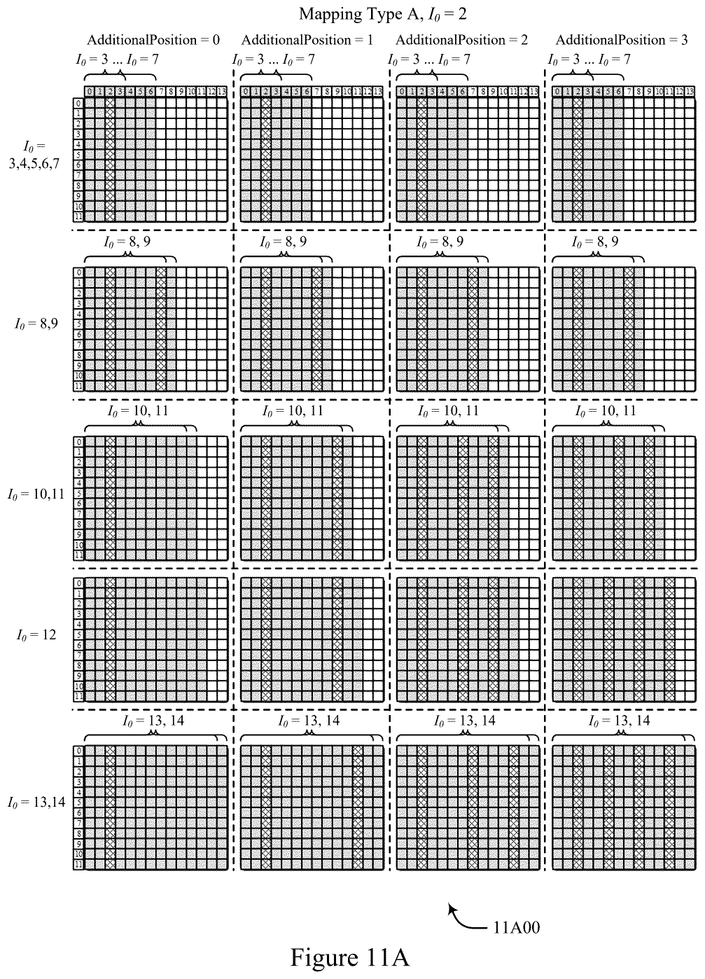

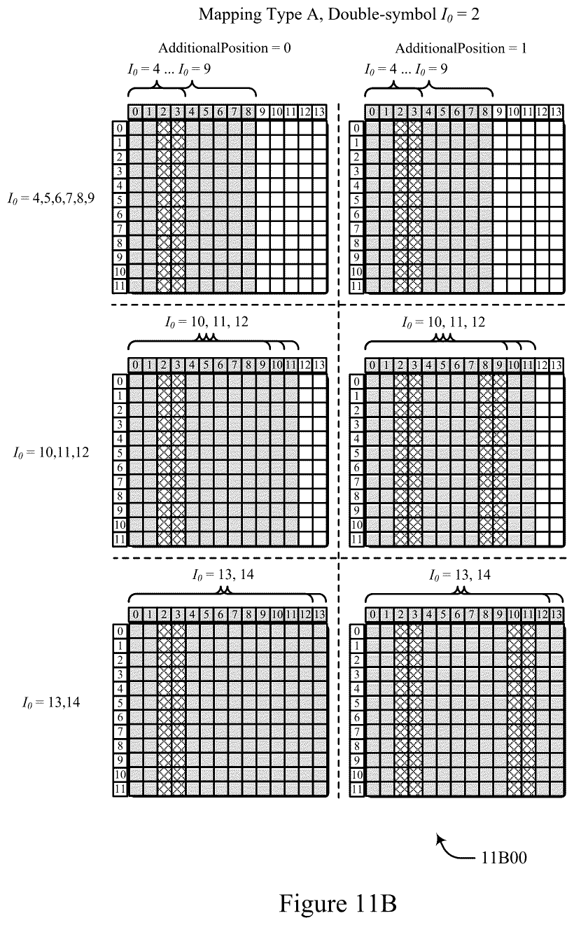

FIGS. 11A and 11B illustrate an example 1100 of DMRS patterns for mapping Type A with front-load DMRS, in accordance with aspects of the present disclosure. In this example 1100, the time domain mapping of the DMRS patterns can be decomposed to two parts. For example the first part defines the DMRS pattern used for the front-load DMRS, and then the second part defines a set of additional DMRS symbols inside the scheduled data channel duration which are either single-symbols, or double-symbols, depending on the length of the front-load DMRS. Inside the scheduled time-domain allocation of a PDSCH, the UE may expect up to four DMRS symbols. The location of the DMRS is defined by both higher-layer configuration and dynamic (DCI-based) signaling, such as DMRS-TypeA-Position, maxLength, and DMRS-AdditionalPosition. When double-symbol DMRS is used, there can be up to one more double-symbol DMRS (total four DMRS symbols inside the PDSCH allocation). Different DMRS patterns for mapping Type A with front-load DMRS are shown in the example 1100.

In the absence of CSI-RS configuration, and unless otherwise configured, the UE may assume PDSCH DMRS and synchronization signal (SS)/physical broadcast channel (PBCH) block antenna ports are quasi co-located with respect to Doppler shift, Doppler spread, average delay, delay spread, and spatial receive (RX) parameters (if applicable). However, a CSI-RS for tracking can be used as a QCL reference (e.g., having larger bandwidth than an SS/PBCH block). Furthermore, the UE may assume that the PDSCH DMRS within the same CDM group are quasi co-located with respect to Doppler shift, Doppler spread, average delay, delay spread, and spatial RX. The UE may then perform a joint estimation of DMRS ports which are CDMed using the same long-term statistics, and it is not required to measure, or use, different long-term statistics for different DMRS ports of the same PDSCH.

In some implementations, the terms antenna, panel, and antenna panel are used interchangeably. An antenna panel may be a hardware that is used for transmitting and/or receiving radio signals at frequencies lower than 6 GHz (e.g., frequency range 1 (FR1)), or higher than 6 GHz (e.g., frequency range 2 (FR2)) or millimeter wave (mmWave). In some implementations, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some implementations, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices, it can be used for signaling or local decision making.

In some implementations, a device (e.g., a UE, a node) antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel or device panel may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some implementations, depending on a device implementation, a device panel can have at least one of the following functionalities as an operational role of a unit of antenna group to control its transmit (TX) beam independently, the unit of antenna group to control its transmission power independently, and/or the unit of antenna group to control its transmission timing independently. The device panel may be transparent to a gNB. For certain condition(s), a gNB or network can assume the mapping between a device's physical antennas to the logical entity device panel may not be changed. For example, the condition may include until the next update or report from a device, or comprise a duration of time over which the gNB assumes there will be no change to the mapping. A device may report its capability with respect to the device panel to the gNB or network. The device capability may include at least the number of device panels. In one implementation, the device may support UL transmission from one beam within a panel, with multiple panels, and more than one beam (one beam per panel) may be used for UL transmission. In another implementation, more than one beam per panel may be supported or used for UL transmission.

In some of the implementations, an antenna port is defined such that the channel over which a symbol on the antenna port is conveyed can be inferred from the channel over which another symbol on the same antenna port is conveyed. Two antenna ports are said to have QCL if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial RX parameters. Two antenna ports may be quasi-located with respect to a subset of the large-scale properties and a different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, a QCL-Type may take one of the following values: QCL-TypeA: {Doppler shift, Doppler spread, average delay, delay spread}; QCL-TypeB: {Doppler shift, Doppler spread}; QCL-TypeC: {Doppler shift, average delay}; QCL-TypeD: {Spatial RX parameter}. Spatial RX parameters may include one or more of: angle of arrival (AoA) Dominant AoA, average AoA, angular spread, power angular spectrum (PAS) of AoA, average AoD (angle of departure), PAS of AoD, transmit/receive channel correlation, transmit/receive beamforming, spatial channel correlation, etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission (i.e., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same RX beamforming weights).

An antenna port may be a logical port that corresponds to a beam (resulting from beamforming) or corresponds to a physical antenna on a device. In some implementations, a physical antenna may map directly to a single antenna port, in which case an antenna port corresponds to an actual physical antenna. Alternately, a set or subset of physical antennas, or an antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the implementations described, a TCI state associated with a target transmission can indicate parameters for configuring a quasi-collocation relationship between the target transmission (e.g., target RS of DMRS ports of the target transmission during a transmission occasion) and source reference signal(s) (e.g., SSB/CSI-RS/sounding reference signal (SRS)) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the implementations described, a TCI state comprises at least one source RS to provide a reference (UE assumption) for determining QCL and/or spatial filter.

In some of the implementations described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception of the reference RS (e.g., downlink (DL) RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In some of the implementations described, an UL TCI state is provided if a device is configured with separate DL/UL TCI by RRC signaling. The UL TCI state may comprise a source reference signal which provides a reference for determining an UL spatial domain transmission filter for the UL transmission (e.g., dynamic-grant/configured-grant based PUSCH, dedicated PUCCH resources) in a CC or across a set of configured CCs or bandwidth parts (BWPs).

In some implementations, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated physical downlink control channel (PDCCH)/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

In aspects of this disclosure, terms that may be used interchangeably include network node, transmit-receive point (TRP), panel, set of antennas, set of antenna ports, uniform linear array, cell, node, radio head, communication (e.g., signals/channels) associated with a control resource set (CORESET) pool, and communication associated with a TCI state from a transmission configuration comprising at least two TCI states. A TRS corresponds to an NZP CSI-RS resource set with a parameter ‘trs-info’ being configured, and a CSI-RS for beam management corresponds to an NZP CSI-RS resource set with a parameter ‘repetition’ being configured. A CSI-RS for CSI corresponds to an NZP CSI-RS resource set with neither parameters ‘trs-info’ nor ‘repetition’ being configured. A matrix implies a sequence of fields of an arbitrary dimension, including an array (vector) of values, a standard 2D matrix and more generally a Q-dimensional matrix (tensor) wherein Q≥2 is an integer value. A mapping between a transport block and a codeword transmitted in DL can be based on a one-to-one mapping between the TBs and codewords.

Aspects of the present disclosure are described in the context of a wireless communications system, and include implementations that provide for robust AI/ML configuration across different network vendors and UE vendors, without the need for substantial coordination on the AI/ML model structure and organization. The described techniques include an RS transmission and measurement phase that precedes a model monitoring decision and/or recommendation to enable AI/ML model switching based on the model functionality, or the AI/ML model features. The described techniques also include signaling implementations to convey model switching, as well as transmission and/or reception configuration, between the network side and the UE side for proper coordination between both sides of the communications network, given the environment and configuration changes.

Aspects of the present disclosure support using one or more AI/ML models or algorithms (e.g., a neural network, AI algorithms). For example, a UE and/or network entity may include an AI/ML model or algorithm, a neural network, and/or any other type of machine learning model to implement the described techniques. In implementations, a network entity may be any node (e.g., base station, gNB, network component, network equipment (NE), logical node) in a wireless communications system, and may be a physical and/or logical implementation (e.g., distributed across multiple network entities and/or devices). As used herein, AI and/or a machine learning model refers to a computer representation that is trainable based on inputs to approximate unknown functions. For example, a machine learning model can utilize algorithms to learn from, and make predictions on, inputs of known data (e.g., training and/or reference data) by analyzing the known data to learn to generate outputs. In aspects of the present disclosure, characteristics, datasets, parameters, and/or values corresponding to AI/ML models may be measured and/or determined to identify an AI/ML model in a wireless communications system. Additionally, reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure include a pre-trained AI/ML models indication of a codebook subset restriction. Assumptions on the AI/ML model side include, for one-sided AI/ML model(s), a model has been trained by the network side or has been trained by the UE side. For a two-sided AI/ML model, a first part of the model (e.g., an encoder of an autoencoder) has been trained at the UE side, and a second part of the model (e.g., a decoder of an autoencoder) has been trained at the network side.

Implementations for one-sided models assume a set of models

$${\{ {M}_{i} \}}_{i = 1}^{K}$$

where K>>1, whereas for two sided models (e.g., auto-encoder models) a first set of Kₑ encoder models

$${\{ {M}_{i}^{( e )} \}}_{i = 1}^{{K}_{e}}$$

and a second set of K_{d} decoder models

$${\{ {M}_{i}^{( d )} \}}_{i = 1}^{{K}_{d}}$$

are assumed, where both Kₑ>>1, K_{d}>>1. Note that Kₑ and K_{d} may not be equal (i.e., encoder and decoder models are not one-to-one mapped). Further, for a static gNB/UE, quasi-static channel (e.g., in a lab environment), one AI/ML model suffices to characterize CSI, BM, and possibly positioning enhancements. For a given environment, encoder and decoder models corresponding to

$${g}_{y \vert x}^{{T}_{i}} and {f}_{y \vert x}^{{R}_{j}}$$

are utilized at a given time, which is trained based on datasets Tᵢ, Rⱼ, respectively. For all models, the domain X (i.e., the domain of input to the encoder) is assumed to span the entire respective sub-space (i.e., for any input vector x), an output vector y exists, regardless of the precision and/or accuracy of y. When the environment changes, the serving cell or served UE changes, or after some UE orientation change, the model may need to change since the underlying distribution P(x,y) over which the model is built has changed.

Aspects of the present disclosure include AI/ML model switching and takes into account different triggers for model switching decisions. In a first implementation, the AI/ML model selection, activation, deactivation, or switching is based on a value of at least one key performance indicator (KPI) parameter including, but not limited to, one of a CQI value, a RSRP value, a signal-to-interference-and-noise-ratio (SINR) value, a handover request (e.g., based on L3 measurements, or an acknowledgement (ACK)/negative acknowledgement (NACK)), a TDCP value corresponding to a channel autocorrelation in a time domain, synchronization estimation values over at least one of a time domain, a frequency domain, or a phase domain, a reciprocity-based UL measurement, a positioning parameter change, a certain time threshold set by one of the network or UE sides, or both, or a measure of a similarity based on a sinusoidal function (e.g., a cosine similarity), or some combination thereof. In an example, the AI/ML model selection, activation, deactivation, or switching is based on a change of the value of the at least one parameter, where the change is a drop of the value below a given threshold, or an increase of the value above a given threshold.

In a second implementation, the AI/ML model selection, activation, deactivation, or switching is based on a value of at least one KPI parameter corresponding to at least one AI/ML related parameter, including, but not limited to, a measure of a complexity of an AI/ML model, a number of processing units required to operate the model, a number of floating point operations per second (FLOPS) associated with the model, a depth of a neural network (NN) associated with the model (i.e., a number of layers and/or hidden layers of the NN), or a combination thereof.

In a third implementation, the AI/ML model switching from a first AI/ML model to a second AI/ML model is based on a relative value of at least a first KPI parameter corresponding to the first model with respect to at least a second KPI parameter corresponding to the second model. In an example, the model switching from the first model to the second model is based on a relative difference of the at least the first KPI parameter and the at least the second KPI parameter being larger than a given threshold.

In a fourth implementation, the AI/ML model selection, activation, deactivation, or switching is based on an event that is configured at the network side and observed and/or measured at the UE side, where an occurrence of the event triggers the UE to report an indication of the event occurrence to the network side. In an example, the indication is in a form of an uplink (UL) signal over a physical channel. In another example, the indication is in a form of a MAC-CE transmitted in UL direction. In another example, the indication is in a form of an RRC signal in the UL direction.

In a fifth implementation, an AI/ML model selection, activation, deactivation, or switching from a first AI/ML model to a second AI/ML model is based on the first AI/ML model achieving a KPI merit value that is below a first threshold value, the second AI/ML model achieving a KPI merit value that is above a second threshold value, a difference in the KPI merit value of the second AI/ML model and the first AI/ML model exceeds a third threshold value, or a combination thereof. In a sixth implementation, a recommendation corresponding to the AI/ML model selection, activation, deactivation, or switching is signaled from a UE side to a network side as part of a monitoring report associated with an AI/ML model configuration. In a seventh implementation, an indication corresponding to the AI/ML model selection, activation, deactivation, or switching is signaled from a network side to a UE side as part of a configuration indication, including, but not limited to, a TCI signaling, an AI/ML configuration indication signaling, a CSI reporting configuration, a positioning configuration, a mobility configuration, or a combination thereof.

In an eighth implementation, a parameter corresponding to an AI/ML model switching associated with a model monitoring procedure includes an indication of at least one of the following levels: Level-0, no model change, which applies when the performance based on the same AI/ML model is stable. Level-1, auxiliary parameters update, in which the AI/ML model is unchanged, but a few non-AI/ML model parameter values are to be updated. Level-2, model parameters update, in which the structure of an AI/ML model is unchanged, but some AI/ML model parameter values are to be updated. Level-3, model switching, such as switching from one AI/ML model to another from a set of pre-configured AI/ML models. Level-4, fallback to a non-AI scheme by switching to a legacy non-AI/ML scheme (e.g., Rel-18 Type-II Doppler codebook).

In a ninth implementation, an AI/ML model selection, activation, deactivation, or switching is associated with processing time corresponding to at least one of a time period for the selection, activation, deactivation, or switching. In some examples, the processing time is larger than a threshold value, and a UE falls back to a default scheme during the processing time, until an AI/ML model selection, activation, deactivation, or switching is initiated.

Aspects of the present disclosure include QCL relationship across datasets. In order to convey an AI/ML model selection, activation, deactivation, or switching determination from one side to another (e.g., from the network side to the UE side), an explicit signaling of a model-based ID, or a set of labels (i.e., metadata) associated with an AI/ML model can be implemented, where the model-based ID and/or the metadata may be associated with a training dataset associated with the AI/ML model. Alternatively, the AI/ML model selection, activation, deactivation, or switching decision from one side to another may be conveyed via signaling of a set of characteristics associated with channel state conditions, environment details, transmission, and/or reception configurations, where the set of characteristics can be mapped to at least one AI/ML model. Several implementations are described herein, including a combination of one or more implementations.

In a first implementation, an AI/ML model is associated with a training dataset that is assigned a set of labels corresponding to metadata of the training dataset, and each label can be associated with multiple label values. In some examples, the set of labels and their associated label values include one or more of: an environment, such as indoor, outdoor rural, outdoor urban, outdoor car; an area or site as enumerated values (e.g., 1, 2, 3, . . . ); a gNB antenna configuration (TX DL and/or RX UL), including virtualization (implementation based); a UE antenna configuration (RX DL and/or TX UL), including virtualization (implementation based); a carrier frequency or frequency range (FR1, FR2, or FR3); a frequency resolution (signal block (SB) size for SB CSI dataset points); a time resolution corresponding to a CSI measurement phase duration, or a time stamp associated with accumulated CSI measuring; a UE speed, such as 15 km/hm, 30 km/hr, etc.; and/or a RS configuration, as related to the layout of the RS used for measurements, if applicable.

In an example, a label in the set of labels of a training dataset is associated with a vector of values (e.g., an antenna configuration label may include a vector of values corresponding to a number of antenna ports across a first dimension, a number of antenna ports across a second dimension, a polarization method, a tilt angle, a panning angle, or some combination thereof). In another example, a label in the set of labels of a training dataset is associated with a weighted mixture of values (e.g., an environment related label includes a weighted value of 50% indoor, 30% outdoor urban, and 20% outdoor car as values for environment. In another example, a sequence of label values corresponding to the set of labels associated with the training dataset constitute a training dataset ID, and the training dataset ID corresponds to an AI/ML model ID. In another example, the set of labels correspond to a set of AI/ML-based model conditions.

In a second implementation, a first training dataset with a first set of label values is combined, merged, appended, or augmented to a second training dataset with a second set of label values for training an AI/ML model, where a subset of labels across the first training dataset and the second training dataset are the same. In an example at least one label in the subset of labels is associated with a same value for both the first training dataset and the second training dataset (e.g., two training datasets associated with a same label value for UE speed are combined to train a same AI/ML model). In some implementations, the dataset points of the first training dataset may be pre-processed prior to being combined, merged, appended, or augmented to the second training dataset. For instance, dataset points of the first training dataset associated with a first frequency carrier are pre-processed prior to being combined, merged, appended, or augmented with dataset points of the second training dataset associated with a second frequency carrier to train a common AI/ML model.

In a third implementation, a first training dataset with a first set of label values is linked with a second training dataset with a second set of label values for training an AI/ML model, with respect to at least one label. In an example the first training dataset and the second training dataset are quasi-co-located, quasi-similar (QS), or correlated with respect to a label of the training dataset (e.g., the two training datasets are linked with respect to the UE speed label). In an example, the first training dataset and the second training dataset that are linked are combined, merged, appended, or augmented for training one AI/ML model. As an example, three training datasets with labels correspond to a delay domain, a Doppler domain, and a spatial domain, and the UE delivers the three training datasets to the network side. The first training dataset is quasi co-located with the second training dataset with respect to the delay domain, but not the Doppler domain or the spatial domain (different UE speed and different UE antenna config). The third training dataset is quasi co-located with the first training dataset with respect to the spatial domain and the Doppler domain, but not the delay domain (same UE in a different location). The third training dataset is quasi co-located with the second training dataset with respect to the delay domain (different UE). For a dataset transfer, the metadata may include such QCL relationships.

Aspects of the present disclosure include measurement-based AI/ML configuration. As an alternative the AI/ML model selection, activation, deactivation, or switching decision from one side to another may be conveyed via signaling of a set of characteristics associated with channel state conditions, environment details, transmission, and/or reception configurations, where the set of characteristics can be mapped to at least one AI/ML model.

In a first implementation for an AI/ML model based at least at the UE side, the AI/ML model selection, activation, deactivation, or switching decision may depend on channel characteristics measured at the UE based on first DL RS transmission that includes DL RSs associated with a first phase, and based on that, the UE can at least partially match the channel characteristics corresponding to the measured DL RSs. In an example, the UE computes a measure of a delay domain channel correlation (e.g., a power-delay profile (PDP) or a delay spread of a DL channel) based on a CSI-RS transmission in the DL direction, where an AI/ML model selection at the UE side is based on the computed measure. In another example, the at least one DL RS is a CSI-RS configured with a tracking or synchronization property. In another example, the at least one DL RS is an RS burst of multiple RS resources transmitted over a configured number of time slots. In another example, the at least one DL RS is an RS burst of one or more RS resources transmitted in periodic behavior and/or semi-persistent behavior (i.e., periodic behavior that can be activated or deactivated via a separate trigger).

In a second implementation for an AI/ML model based at least at the network side, the AI/ML model selection, activation, deactivation, or switching decision may depend on channel characteristics measured at the UE based on the first DL RS transmission, and based on that, the UE feeds back a first feedback report that includes the channel characteristics to the network side associated with the first phase, based on the DL RS measured at the UE side. In an example, the UE computes a measure of a delay domain channel correlation (e.g., PDP or a delay spread of a DL channel) based on a CSI-RS transmission in the DL direction, and transmits a feedback report to the network side based on the computed measure. An AI/ML model selection at the network side is based on the feedback report. In another example, the first feedback report is a CSI feedback report, a synchronization report, a time-domain, a delay domain, a frequency domain, or Doppler domain channel property report, or a combination thereof. In another example, the first feedback report is configured with an aperiodic behavior (i.e., the CSI feedback report is triggered via a separate configuration message (e.g., a DCI signal). In another example, the first feedback report is configured with periodic behavior or semi-persistent behavior, and a first periodicity value of the first feedback report is larger than a corresponding second periodicity value associated with the DL RSs. In another example, the first feedback report includes a set of labels, a set of corresponding label values, at least one AI/ML model ID, at least one dataset ID, or a combination thereof.

In a third implementation, the first DL RS transmission is followed in time by a second DL RS transmission corresponding to a second phase, and an estimate of channel characteristics measured via the received estimate of the second DL RS transmission is used as an input to an AI/ML model located at least at the UE side. In an example, the second DL RS transmission is configured with aperiodic behavior. In another example, the second DL RS transmission is configured as a CSI-RS transmission based on a CSI-RS resource. In another example, DL RSs associated with the second DL RS transmission are transmitted with less density in time domain, frequency domain or spatial domain, compared with the at least one DL RS associated with the first DL RS transmission.

In a fourth implementation, the second DL RS transmission is followed in time by a second feedback report from the UE side to the network side corresponding to the second phase, and the second feedback report is used as an input to an AI/ML model located at least at the network side. In an example, the second feedback report follows the first feedback report. In another example, the second feedback report is based on the second DL RS transmission, and the second DL RS transmission also follows the first DL RS transmission. In another example, the first feedback report is based on the first DL RS transmission and the second feedback report are the same. In another example, the second feedback report comprises an indication of a configuration ID associated with the first phase, the configuration ID corresponding to a configuration message corresponding to the first DL RS transmission, the first feedback report, or an indication of an AI/ML model ID, a set of label values associated with the training dataset corresponding to the AI/ML model, or a combination thereof.

In other examples, the AI/ML model framework is supported for two-sided AI/ML-based DL CSI compression, where a first part of the AI/ML model resides at the UE side (e.g., an encoder of an autoencoder structure) and a second part of the AI/ML model resides at the network side (e.g., a decoder of the autoencoder structure) wherein the CSI measurement constitutes two phases in time. In a first phase, an RS burst (e.g., periodic RS burst is transmitted to the UE to help the UE side identify the underlying channel distribution corresponding to a certain metadata). In the first phase, the UE identifies the properties of the signal in a delay/Doppler domain, and feeds back this info to the network. The properties correspond to the dataset feature. The UE associates this RS burst with one dataset, but does not share the ID with the network side. Note that explicit signaling of other label values may be needed. In a second phase at the network side, a second RS (sparser than Phase 1) is used as model input at the encoder side. The network side indicates to the UE side that it should use the AI/ML model associated with the first DL RS transmission, since the network side will use the corresponding AI/ML model in CSI reconstruction.

Aspects of the present disclosure include signaling of Aian/ML configuration indication. In order to convey an AI/ML model selection, activation, deactivation, or a switching decision from one side to another, a first communication side (e.g., the UE side) may indicate to a second communication side (e.g., the network side) a dummy ID corresponding to an AI/ML model based on a set of configuration messages, RS transmission, feedback messages, or feedforward messages, and share it with the second communication side so as to enable using a same transmission and/or reception configuration, a same AI/ML model, or a combination thereof, over multiple transmission occasions. Several implementations are described and a combination of one or more implementations may be valid.

In a first implementation, the UE side feeds back an AI/ML model output to the network side, and an ID is generated corresponding to one of the AI/ML model or the underlying report setting configured via the network side. The generated ID can then be used as an indicator or identifier of the AI/ML model in subsequent transmission occasions. In an example, the model output is fed back via a CSI report, the report setting corresponds to a CSI report setting, and the ID corresponds to a CSI report setting ID (i.e., CSI-ReportConfig-ID). In another example, the generated ID is configured to be valid for a period of time, after which a value of the ID is released.

In a second implementation, an RS corresponding to an AI/ML model input, a measurement resource, a pilot signal, or a combination thereof, is quasi-co-located, mapped, or correlated with a corresponding AI/ML model, transmission configuration, scheme, or a combination thereof. In an example, the corresponding AI/ML model, transmission configuration, and/or scheme is associated with an ID. In another example, the QCL, mapping, or correlation are indicated within a TCI state, and the TCI state is included in one of an RRC message, or a MAC-CE signal. In another example, the QCL, mapping, or correlation are indicated within a TCI state, and the TCI state is included in a DCI signaling, where the DCI signaling schedules one of a PUSCH or a PUCCH.

In a third implementation, the network side utilizes an AI/ML model for transmission, reception, or both to and/or from a UE side, and the network side indicates to the UE side of a change in an underlying AI/ML model ID, where the change is signaled to the UE via a DL signal. In an example, the DL signal is a DCI signal transmitted over a DL control channel. In another example, the DL signal is a TCI field in the DCI. In another example, the indication is in a form corresponding to a flag that signals to the UE side whether the underlying AI/ML model has changed.

In a fourth implementation, a first RS associated with an AI/ML-based model is quasi co-located with a second RS, according to a subset of a set of QCL properties. In an example, the set of QCL properties include at least a Doppler shift, a Doppler spread, an average delay, a delay spread, and a spatial parameter. In another example, the set of QCL properties include at least a Doppler shift, a Doppler spread, an average delay, a delay spread and a spatial receiver parameter. In another example, the set of QCL properties include at least one of an environment parameter, an area or site ID parameter, a spatial transmitter parameter, a carrier frequency or frequency range parameter, a frequency resolution parameter (e.g., SCS) a time resolution parameter (e.g., a slot length or training period), a UE speed parameter, and an RS configuration parameter. In another example, the first RS is a zero-power RS (i.e., is not associated with a physical RS transmission). In another example, the second RS is one of a CSI-RS, a CSI-RS configured with tracking, a CSI-RS configured with BM, a DMRS for PDSCH, PUSCH, or PDCCH.

Aspects of the present disclosure include AI/ML configuration indication for model monitoring. In one or more implementations, an AI/ML model selection, activation, deactivation, or switching decision is based on a monitoring procedure, where the monitoring procedure involves both the UE side and the network side. The monitoring procedure involves a measurement phase, an evaluation or quantification phase of an AI/ML model performance, and a monitoring output phase. Several implementations are described herein and a combination of one or more implementations may be valid.

In a first implementation, the measurement phase corresponding to the monitoring procedure includes transmission of a monitoring report that comprises a set of parameters from a first side (e.g., the UE side) to a second side (e.g., the network side). In an example, the monitoring report is a feedback report transmitted from the UE side to the network side, and the feedback report includes an output of an AI/ML model in a prior time, or a higher resolution output compared with a conventional feedback report (e.g., a higher quantization resolution of CSI feedback parameters). In another example, the monitoring report is a sequence of indicators transmitted from the network side to the UE side in a form of DCI.

In a second implementation, the evaluation or quantification phase includes a comparison of a performance of a first AI/ML model with respect to a set of configured performance metric parameters, according to a defined baseline. In an example, the baseline of the AI/ML model performance is a comparison of a second performance of a second AI/ML model with respect to the set of configured performance metric parameters. In another example, the baseline of the AI/ML model performance is a comparison of a second performance of the first AI/ML model in a prior time interval with respect to the set of configured performance metric parameters. In another example, the baseline of the AI/ML model performance is a comparison of a fixed, or pre-configured performance threshold with respect to the set of configured performance metric parameters.

In a third implementation, the monitoring output phase includes a recommended AI/ML model selection, activation, deactivation, or switching decision, or an AI/ML selection, activation, deactivation, or switching decision from one side to another. In an example, the recommended AI/ML model selection, activation, deactivation, or switching decision is transmitted from the UE side to the network side. In another example, the AI/ML model selection, activation, deactivation, or switching decision is transmitted from the network side to the UE side. In another example, the monitoring output comprises an identification of an AI/ML model, where the identification of the AI/ML model is in a form of a set of label values associated with the AI/ML model. In another example, the monitoring output includes an identification of an AI/ML model, and the identification of the AI/ML model is an update of a QCL relationship, a quasi-similarity, a correlation signaling, or a TCI update corresponding to an updated AI/ML model with respect to the first AI/ML model.

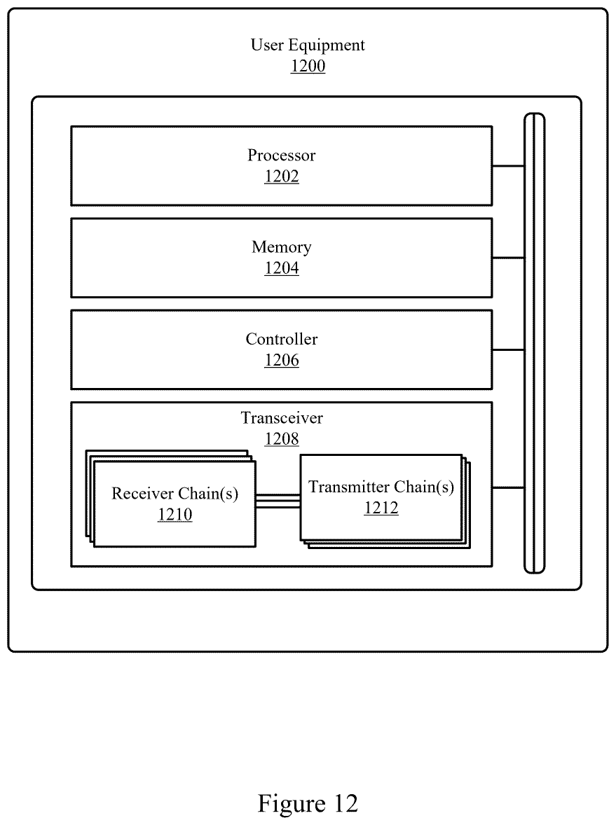

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such as the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein. The UE 1200 may be configured to or operable to support a means for receiving, from a network entity, an AI-based configuration corresponding to at least one of signal transmission or signal reception by the UE, the AI-based configuration associated with one or more AI models, an AI model associated with a dataset; receiving, from the network entity, a reference signal configuration for a set of reference signals, the reference signal configuration paired with the AI-based configuration; measuring a set of report parameters based at least in part on the set of reference signals; and transmitting, to the network entity, a feedback report comprising the set of report parameters, the feedback report usable by the network entity to select the AI model from the one or more AI models.

Additionally, the UE 1200 may be configured to support any one or combination of the one or more AI models are trained at least in part at the UE. The method further comprising measuring channel properties based at least in part on the set of reference signals received at the UE, the channel properties including at least one of a delay-dependent property, a Doppler-dependent property, or a spatial correlation property, and selection of the AI model from the one or more AI models is based on the channel properties. The method further comprising receiving an additional set of reference signals subsequent to receiving the set of reference signals, and a measurement on the additional set of reference signals is an input to the AI model of the one or more AI models. The one or more AI models are trained at the network entity. Selection of the AI model from the one or more AI models is based on the set of report parameters in the feedback report transmitted to the network entity. The set of report parameters in the feedback report include one or more of a TDCP parameter, a time synchronization parameter, a delay synchronization parameter, a frequency synchronization parameter, a Doppler synchronization parameter, a phase synchronization parameter, or a set of approximate values of a set of condition parameters based on the set of reference signals. The method further comprising transmitting, to the network entity, an additional feedback report subsequent to transmitting the feedback report, the additional feedback report comprising input parameters that are usable as input to the AI model of the one or more AI models. The input parameters in the additional feedback report include one or more of an indication of a configuration ID associated with one of the set of reference signals, the feedback report, the AI model, or a set of label values associated with the dataset corresponding to the AI model in the one or more AI models. The reference signal configuration corresponds to a CSI-based configuration. At least one of an identification of the AI model in the one or more AI models is signaled from the UE to the network entity, or the identification of the AI model in the one or more AI models is signaled from the network entity to the UE. The identification of the AI model is based on one or more of a sequence of label values of a training dataset associated with training of the AI model, an ID of at least one of a CSI report setting, a CSI resource setting, a TCI state, a transmission mode reported in one of DCI, UCI, a MAC-CE, a RRC signal, or a ZP reference signal, wherein the ZP reference signal is quasi-co-located with at least one reference signal in the set of reference signals according to one or more QCL properties. Selection of the AI model from the one or more AI models is based at least in part on an AI model monitoring procedure, the AI model monitoring procedure comprising a measurement phase, an evaluation phase, and a monitoring output phase. The measurement phase corresponds to signaling of a monitoring report comprising a set of performance monitoring parameters measured at the UE or at the network entity. The monitoring report is one of received by the UE as a downlink MAC-CE or as a DCI signal, or transmitted by the UE as an uplink MAC-CE or as a UCI signal. The evaluation phase comprises a comparison of a first performance of a first AI model with a second performance of a baseline AI model, the comparison based at least in part on the set of performance monitoring parameters; and the second performance of the baseline AI model corresponds to at least one of a performance of a second AI model, the first performance of the first AI model at a prior time interval compared with another time interval of the first performance of the first AI model, or a fixed set or a pre-configured set of performance monitoring parameter values. The monitoring output phase comprises at least one of a recommended AI model selection indication provided by the UE, or an AI model selection command provided by the network entity; and the recommended AI model selection indication is at least one of an ID of the AI model, a set of label values corresponding to a training dataset corresponding to a trained AI model, a TCI state, correlation information, or a QCL relationship.

Additionally, or alternatively, the UE 1200 may support at least one memory (e.g., the memory 1204) and at least one processor (e.g., the processor 1202) coupled with the at least one memory and configured to cause the UE to receive, from a network entity, an AI-based configuration corresponding to at least one of signal transmission or signal reception by the UE, the AI-based configuration associated with one or more AI models, an AI model associated with a dataset; receive, from the network entity, a reference signal configuration for a set of reference signals, the reference signal configuration paired with the AI-based configuration; measure a set of report parameters based at least in part on the set of reference signals; and transmit, to the network entity, a feedback report comprising the set of report parameters, the feedback report usable by the network entity to select the AI model from the one or more AI models.

Additionally, the UE 1200 may be configured to support any one or combination of the one or more AI models are trained at least in part at the UE. The at least one processor is configured to cause the UE to measure channel properties based at least in part on the set of reference signals received at the UE, the channel properties including at least one of a delay-dependent property, a Doppler-dependent property, or a spatial correlation property, and selection of the AI model from the one or more AI models is based on the channel properties. The at least one processor is configured to cause the UE to receive an additional set of reference signals subsequent to receiving the set of reference signals, and a measurement on the additional set of reference signals is an input to the AI model of the one or more AI models. The one or more AI models are trained at the network entity. Selection of the AI model from the one or more AI models is based on the set of report parameters in the feedback report transmitted to the network entity. The set of report parameters in the feedback report include one or more of a TDCP parameter, a time synchronization parameter, a delay synchronization parameter, a frequency synchronization parameter, a Doppler synchronization parameter, a phase synchronization parameter, or a set of approximate values of a set of condition parameters based on the set of reference signals. The at least one processor is configured to cause the UE to transmit, to the network entity, an additional feedback report subsequent to transmitting the feedback report, the additional feedback report comprising input parameters that are usable as input to the AI model of the one or more AI models. The input parameters in the additional feedback report include one or more of an indication of a configuration ID associated with one of the set of reference signals, the feedback report, the AI model, or a set of label values associated with the dataset corresponding to the AI model in the one or more AI models. The reference signal configuration corresponds to a CSI-based configuration. At least one of an identification of the AI model in the one or more AI models is signaled from the UE to the network entity, or the identification of the AI model in the one or more AI models is signaled from the network entity to the UE. The identification of the AI model is based on one or more of a sequence of label values of a training dataset associated with training of the AI model, an ID of at least one of a CSI report setting, a CSI resource setting, a TCI state, a transmission mode reported in one of DCI, UCI, a MAC-CE, a RRC signal, or a ZP reference signal, wherein the ZP reference signal is quasi-co-located with at least one reference signal in the set of reference signals according to one or more QCL properties. Selection of the AI model from the one or more AI models is based at least in part on an AI model monitoring procedure, the AI model monitoring procedure comprising a measurement phase, an evaluation phase, and a monitoring output phase. The measurement phase corresponds to signaling of a monitoring report comprising a set of performance monitoring parameters measured at the UE or at the network entity. The monitoring report is one of received by the UE as a downlink MAC-CE or as a DCI signal, or transmitted by the UE as an uplink MAC-CE or as an UCI signal. The evaluation phase comprises a comparison of a first performance of a first AI model with a second performance of a baseline AI model, the comparison based at least in part on the set of performance monitoring parameters; and the second performance of the baseline AI model corresponds to at least one of a performance of a second AI model, the first performance of the first AI model at a prior time interval compared with another time interval of the first performance of the first AI model, or a fixed set or a pre-configured set of performance monitoring parameter values. The monitoring output phase comprises at least one of a recommended AI model selection indication provided by the UE, or an AI model selection command provided by the network entity; and the recommended AI model selection indication is at least one of an ID of the AI model, a set of label values corresponding to a training dataset corresponding to a trained AI model, a TCI state, correlation information, or a QCL relationship.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas to receive a signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

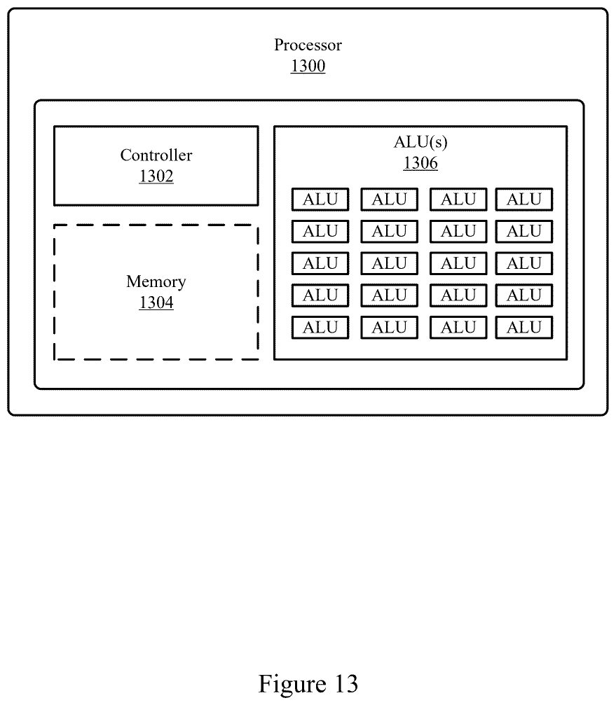

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory addresses of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, ALUs 1306, and other functional units of the processor 1300.

The memory 1304 may include one or more caches (e.g., memory local to or included in the processor 1300 or other memory, such as RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, and the controller 1302, and may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 may be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to support at least one controller (e.g., the controller 1302) coupled with at least one memory (e.g., the memory 1304) and configured to cause the processor to receive, from a network entity, an AI-based configuration corresponding to at least one of signal transmission or signal reception, the AI-based configuration associated with one or more AI models, an AI model associated with a dataset; receive, from the network entity, a reference signal configuration for a set of reference signals, the reference signal configuration paired with the AI-based configuration; measure a set of report parameters based at least in part on the set of reference signals; and transmit, to the network entity, a feedback report comprising the set of report parameters, the feedback report usable by the network entity to select the AI model from the one or more AI models.

Additionally, the processor 1300 may be configured to or operable to support any one or combination of the one or more AI models are trained at least in part at a UE. The at least one controller is configured to cause the processor to measure channel properties based at least in part on the set of reference signals received at the UE, the channel properties including at least one of a delay-dependent property, a Doppler-dependent property, or a spatial correlation property, and selection of the AI model from the one or more AI models is based on the channel properties. The at least one controller is configured to cause the processor to receive an additional set of reference signals subsequent to receiving the set of reference signals, and a measurement on the additional set of reference signals is an input to the AI model of the one or more AI models. The one or more AI models are trained at the network entity. Selection of the AI model from the one or more AI models is based on the set of report parameters in the feedback report transmitted to the network entity. The set of report parameters in the feedback report include one or more of a TDCP parameter, a time synchronization parameter, a delay synchronization parameter, a frequency synchronization parameter, a Doppler synchronization parameter, a phase synchronization parameter, or a set of approximate values of a set of condition parameters based on the set of reference signals. The at least one controller is configured to cause the processor to transmit, to the network entity, an additional feedback report subsequent to transmitting the feedback report, the additional feedback report comprising input parameters that are usable as input to the AI model of the one or more AI models. The input parameters in the additional feedback report include one or more of an indication of a configuration ID associated with one of the set of reference signals, the feedback report, the AI model, or a set of label values associated with the dataset corresponding to the AI model in the one or more AI models. The reference signal configuration corresponds to a CSI-based configuration. At least one of an identification of the AI model in the one or more AI models is signaled from a UE to the network entity, or the identification of the AI model in the one or more AI models is signaled from the network entity to the UE. The identification of the AI model is based on one or more of a sequence of label values of a training dataset associated with training of the AI model, an ID of at least one of a CSI report setting, a CSI resource setting, a TCI state, a transmission mode reported in one of DCI, UCI, a MAC-CE, a RRC signal, or a ZP reference signal, wherein the ZP reference signal is quasi-co-located with at least one reference signal in the set of reference signals according to one or more QCL properties. Selection of the AI model from the one or more AI models is based at least in part on an AI model monitoring procedure, the AI model monitoring procedure comprising a measurement phase, an evaluation phase, and a monitoring output phase. The measurement phase corresponds to signaling of a monitoring report comprising a set of performance monitoring parameters measured at a UE or at the network entity. The monitoring report is one of received by the UE as a downlink MAC-CE or as a DCI signal, or transmitted by the UE as an uplink MAC-CE or as a UCI signal. The evaluation phase comprises a comparison of a first performance of a first AI model with a second performance of a baseline AI model, the comparison based at least in part on the set of performance monitoring parameters; and the second performance of the baseline AI model corresponds to at least one of a performance of a second AI model, the first performance of the first AI model at a prior time interval compared with another time interval of the first performance of the first AI model, or a fixed set or a pre-configured set of performance monitoring parameter values. The monitoring output phase comprises at least one of a recommended AI model selection indication provided by the UE, or an AI model selection command provided by the network entity; and the recommended AI model selection indication is at least one of an ID of the AI model, a set of label values corresponding to a training dataset corresponding to a trained AI model, a TCI state, correlation information, or a QCL relationship.

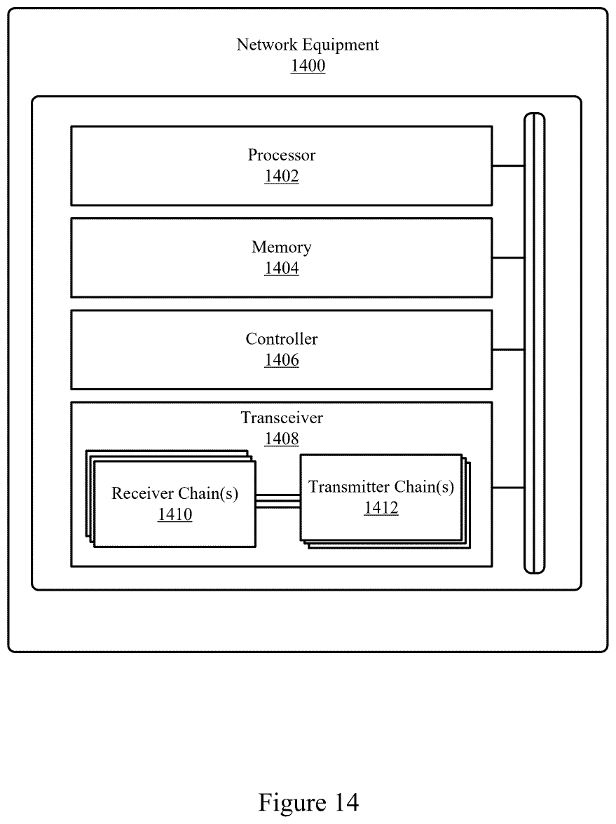

FIG. 14 illustrates an example of a NE 1400 in accordance with aspects of the present disclosure. In one or more implementations, the NE 1400 may be a network entity, to include a network device, logical component, or combination thereof. In implementations, a network entity may be any node (e.g., base station, gNB, network component, network equipment (NE), logical node) in a wireless communications system, and may be a physical and/or logical implementation (e.g., distributed across multiple network entities and/or devices). The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein. As a network entity, the NE 1400 may be configured to or operable to support a means for transmitting, to a UE, an AI-based configuration corresponding to at least one of signal transmission or signal reception by the UE, the AI-based configuration associated with one or more AI models, an AI model associated with a dataset; transmitting, to the UE, a reference signal configuration for a set of reference signals, the reference signal configuration paired with the AI-based configuration; receiving, from the UE, a feedback report comprising a set of report parameters; and selecting the AI model based at least in part on the set of report parameters.

Additionally, the network entity 1400 may be configured to or operable to support any one or combination of the one or more AI models are trained at least in part at a UE. The method further comprising transmitting an additional reference signal configuration for an additional set of reference signals subsequent to receiving the set of reference signals, and a measurement on the additional set of reference signals is an input to the AI model of the one or more AI models. The one or more AI models are trained at the network entity. Selection of the AI model from the one or more AI models is based on the set of report parameters in the feedback report received from the UE. The set of report parameters in the feedback report include one or more of a TDCP parameter, a time synchronization parameter, a delay synchronization parameter, a frequency synchronization parameter, a Doppler synchronization parameter, a phase synchronization parameter, or a set of approximate values of a set of condition parameters based on the set of reference signals. The method further comprising receiving, from the UE, an additional feedback report subsequent to receiving the feedback report, the additional feedback report comprising input parameters that are usable as input to the AI model of the one or more AI models. The input parameters in the additional feedback report include one or more of an indication of a configuration ID associated with one of the set of reference signals, the feedback report, the AI model, or a set of label values associated with the dataset corresponding to the AI model in the one or more AI models. The reference signal configuration corresponds to a CSI-based configuration. At least one of an identification of the AI model in the one or more AI models is signaled from a UE to the network entity, or the identification of the AI model in the one or more AI models is signaled from the network entity to the UE. The identification of the AI model is based on one or more of a sequence of label values of a training dataset associated with training of the AI model, an ID of at least one of a CSI report setting, a CSI resource setting, a TCI state, a transmission mode reported in one of DCI, UCI, a MAC-CE, a RRC signal, or a ZP reference signal, wherein the ZP reference signal is quasi-co-located with at least one reference signal in the set of reference signals according to one or more QCL properties. Selection of the AI model from the one or more AI models is based at least in part on an AI model monitoring procedure, the AI model monitoring procedure comprising a measurement phase, an evaluation phase, and a monitoring output phase. The measurement phase corresponds to signaling of a monitoring report comprising a set of performance monitoring parameters measured at a UE or at the network entity. The monitoring report is one of received by the UE as a downlink MAC-CE or as a DCI signal, or transmitted by the UE as an uplink MAC-CE or as a UCI signal. The evaluation phase comprises a comparison of a first performance of a first AI model with a second performance of a baseline AI model, the comparison based at least in part on the set of performance monitoring parameters; and the second performance of the baseline AI model corresponds to at least one of a performance of a second AI model, the first performance of the first AI model at a prior time interval compared with another time interval of the first performance of the first AI model, or a fixed set or a pre-configured set of performance monitoring parameter values. The monitoring output phase comprises at least one of a recommended AI model selection indication provided by the UE, or an AI model selection command provided by the network entity; and the recommended AI model selection indication is at least one of an ID of the AI model, a set of label values corresponding to a training dataset corresponding to a trained AI model, a TCI state, correlation information, or a QCL relationship.

Additionally, or alternatively, the network entity 1400 may support at least one memory (e.g., the memory 1404) and at least one processor (e.g., the processor 1402) coupled with the at least one memory and configured to cause the network entity to transmit, to a UE, an AI-based configuration corresponding to at least one of signal transmission or signal reception by the UE, the AI-based configuration associated with one or more AI models, an AI model associated with a dataset; transmit, to the UE, a reference signal configuration for a set of reference signals, the reference signal configuration paired with the AI-based configuration; receive, from the UE, a feedback report comprising a set of report parameters; and select the AI model based at least in part on the set of report parameters.

Additionally, the network entity 1400 may be configured to support any one or combination of the one or more AI models are trained at least in part at a UE. The at least one processor is configured to cause the network entity to transmit an additional reference signal configuration for an additional set of reference signals subsequent to receiving the set of reference signals, and a measurement on the additional set of reference signals is an input to the AI model of the one or more AI models. The one or more AI models are trained at the network entity. Selection of the AI model from the one or more AI models is based on the set of report parameters in the feedback report received from the UE. The set of report parameters in the feedback report include one or more of a TDCP parameter, a time synchronization parameter, a delay synchronization parameter, a frequency synchronization parameter, a Doppler synchronization parameter, a phase synchronization parameter, or a set of approximate values of a set of condition parameters based on the set of reference signals. The at least one processor is configured to cause the network entity to receive, from the UE, an additional feedback report subsequent to receiving the feedback report, the additional feedback report comprising input parameters that are usable as input to the AI model of the one or more AI models. The input parameters in the additional feedback report include one or more of an indication of a configuration ID associated with one of the set of reference signals, the feedback report, the AI model, or a set of label values associated with the dataset corresponding to the AI model in the one or more AI models. The reference signal configuration corresponds to a CSI-based configuration. At least one of an identification of the AI model in the one or more AI models is signaled from a UE to the network entity, or the identification of the AI model in the one or more AI models is signaled from the network entity to the UE. The identification of the AI model is based on one or more of a sequence of label values of a training dataset associated with training of the AI model, an ID of at least one of a CSI report setting, a CSI resource setting, a TCI state, a transmission mode reported in one of DCI, UCI, a MAC-CE, a RRC signal, or a ZP reference signal, wherein the ZP reference signal is quasi-co-located with at least one reference signal in the set of reference signals according to one or more QCL properties. Selection of the AI model from the one or more AI models is based at least in part on an AI model monitoring procedure, the AI model monitoring procedure comprising a measurement phase, an evaluation phase, and a monitoring output phase. The measurement phase corresponds to signaling of a monitoring report comprising a set of performance monitoring parameters measured at a UE or at the network entity. The monitoring report is one of received by the UE as a downlink MAC-CE or as a DCI signal, or transmitted by the UE as an uplink MAC-CE or as a UCI signal. The evaluation phase comprises a comparison of a first performance of a first AI model with a second performance of a baseline AI model, the comparison based at least in part on the set of performance monitoring parameters; and the second performance of the baseline AI model corresponds to at least one of a performance of a second AI model, the first performance of the first AI model at a prior time interval compared with another time interval of the first performance of the first AI model, or a fixed set or a pre-configured set of performance monitoring parameter values. The monitoring output phase comprises at least one of a recommended AI model selection indication provided by the UE, or an AI model selection command provided by the network entity; and the recommended AI model selection indication is at least one of an ID of the AI model, a set of label values corresponding to a training dataset corresponding to a trained AI model, a TCI state, correlation information, or a QCL relationship.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas to receive a signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

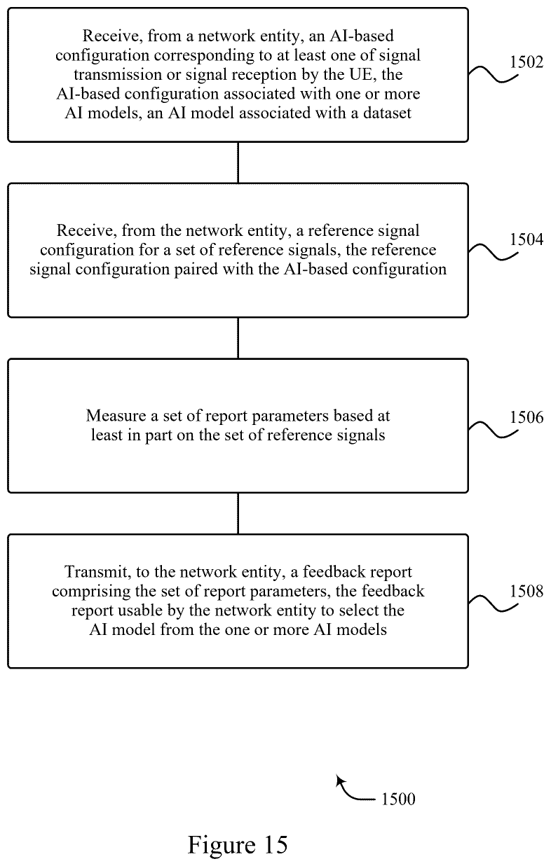

FIG. 15 illustrates a flowchart of a method 1500 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1502, the method may include receiving, from a network entity, an AI-based configuration corresponding to at least one of signal transmission or signal reception by the UE, the AI-based configuration associated with one or more AI models, an AI model associated with a dataset. The operations of 1502 may be performed in accordance with examples as described herein. In some implementations, aspects of the operations of 1502 may be performed by a UE as described with reference to FIG. 12.

At 1504, the method may include receiving, from the network entity, a reference signal configuration for a set of reference signals, the reference signal configuration paired with the AI-based configuration. The operations of 1504 may be performed in accordance with examples as described herein. In some implementations, aspects of the operations of 1504 may be performed by a UE as described with reference to FIG. 12.

At 1506, the method may include measuring a set of report parameters based at least in part on the set of reference signals. The operations of 1506 may be performed in accordance with examples as described herein. In some implementations, aspects of the operations of 1506 may be performed a UE as described with reference to FIG. 12.

At 1508, the method may include transmitting, to the network entity, a feedback report comprising the set of report parameters, the feedback report usable by the network entity to select the AI model from the one or more AI models. The operations of 1508 may be performed in accordance with examples as described herein. In some implementations, aspects of the operations of 1508 may be performed a UE as described with reference to FIG. 12.

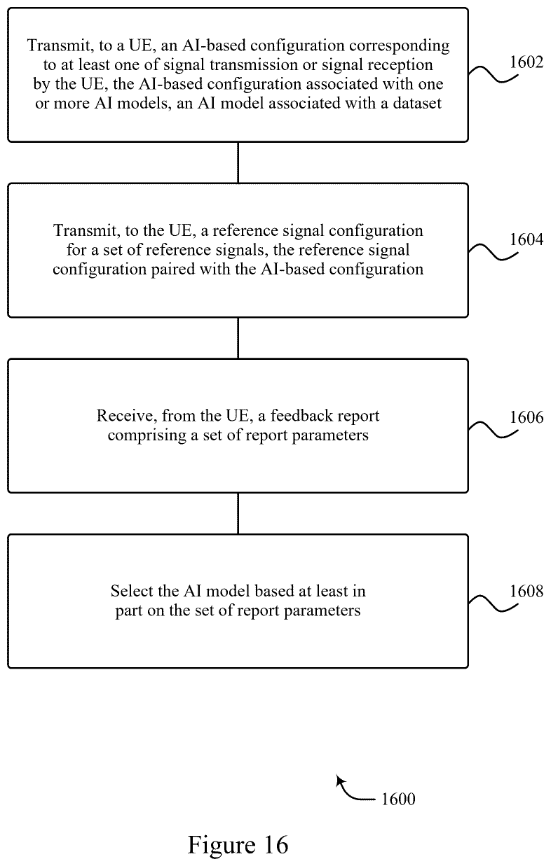

FIG. 16 illustrates a flowchart of a method 1600 in accordance with aspects of the present disclosure. The operations of the method may be implemented by a network entity as described herein. In some implementations, the network entity may execute a set of instructions to control the function elements of the network entity to perform the described functions. It should be noted that the method described herein describes a possible implementation, and that the operations and the steps may be rearranged or otherwise modified and that other implementations are possible.

At 1602, the method may include transmitting, to a UE, an AI-based configuration corresponding to at least one of signal transmission or signal reception by the UE, the AI-based configuration associated with one or more AI models, an AI model associated with a dataset. The operations of 1602 may be performed in accordance with examples as described herein. In some implementations, aspects of the operations of 1602 may be performed by a network entity as described with reference to FIG. 14.

At 1604, the method may include transmitting, to the UE, a reference signal configuration for a set of reference signals, the reference signal configuration paired with the AI-based configuration. The operations of 1604 may be performed in accordance with examples as described herein. In some implementations, aspects of the operations of 1604 may be performed by a network entity as described with reference to FIG. 14.

At 1606, the method may include receiving, from the UE, a feedback report comprising a set of report parameters. The operations of 1606 may be performed in accordance with examples as described herein. In some implementations, aspects of the operations of 1606 may be performed a network entity as described with reference to FIG. 14.

At 1608, the method may include selecting the AI model based at least in part on the set of report parameters. The operations of 1608 may be performed in accordance with examples as described herein. In some implementations, aspects of the operations of 1608 may be performed a network entity as described with reference to FIG. 14.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a network entity, an artificial intelligence (AI)-based configuration corresponding to at least one of signal transmission or signal reception by the UE, the AI-based configuration associated with one or more AI models, an AI model associated with a dataset;
receive, from the network entity, a reference signal configuration for a set of reference signals, the reference signal configuration paired with the AI-based configuration;
measure a set of report parameters based at least in part on the set of reference signals; and
transmit, to the network entity, a feedback report comprising the set of report parameters, the feedback report usable by the network entity to select the AI model from the one or more AI models.

2. The UE of claim 1, wherein the one or more AI models are trained at least in part at the UE.

3. The UE of claim 2, wherein the at least one processor is configured to cause the UE to measure channel properties based at least in part on the set of reference signals received at the UE, the channel properties including at least one of a delay-dependent property, a Doppler-dependent property, or a spatial correlation property, and selection of the AI model from the one or more AI models is based on the channel properties.

4. The UE of claim 2, wherein the at least one processor is configured to cause the UE to receive an additional set of reference signals subsequent to receiving the set of reference signals, and a measurement on the additional set of reference signals is an input to the AI model of the one or more AI models.

5. The UE of claim 1, wherein the one or more AI models are trained at the network entity.

6. The UE of claim 5, wherein selection of the AI model from the one or more AI models is based on the set of report parameters in the feedback report transmitted to the network entity.

7. The UE of claim 6, wherein the set of report parameters in the feedback report include one or more of a time-domain channel property (TDCP) parameter, a time synchronization parameter, a delay synchronization parameter, a frequency synchronization parameter, a Doppler synchronization parameter, a phase synchronization parameter, or a set of approximate values of a set of condition parameters based on the set of reference signals.

8. The UE of claim 5, wherein the at least one processor is configured to cause the UE to transmit, to the network entity, an additional feedback report subsequent to transmitting the feedback report, the additional feedback report comprising input parameters that are usable as input to the AI model of the one or more AI models.

9. The UE of claim 8, wherein the input parameters in the additional feedback report include one or more of an indication of a configuration identifier (ID) associated with one of the set of reference signals, the feedback report, the AI model, or a set of label values associated with the dataset corresponding to the AI model in the one or more AI models.

10. The UE of claim 1, wherein the reference signal configuration corresponds to a channel state information (CSI)-based configuration.

11. The UE of claim 1, wherein at least one of an identification of the AI model in the one or more AI models is signaled from the UE to the network entity, or the identification of the AI model in the one or more AI models is signaled from the network entity to the UE.

12. The UE of claim 11, wherein the identification of the AI model is based on one or more of a sequence of label values of a training dataset associated with training of the AI model, an identifier (ID) of at least one of a channel state information (CSI) report setting, a CSI resource setting, a transmission configuration indicator (TCI) state, a transmission mode reported in one of downlink control information (DCI), uplink control information (UCI), a medium access control (MAC) control element (MAC-CE), a radio resource control (RRC) signal, or a zero-power (ZP) reference signal, wherein the ZP reference signal is quasi-co-located with at least one reference signal in the set of reference signals according to one or more quasi-co-location (QCL) properties.

13. The UE of claim 1, wherein selection of the AI model from the one or more AI models is based at least in part on an AI model monitoring procedure, the AI model monitoring procedure comprising a measurement phase, an evaluation phase, and a monitoring output phase.

14. The UE of claim 13 wherein the measurement phase corresponds to signaling of a monitoring report comprising a set of performance monitoring parameters measured at the UE or at the network entity.

15. The UE of claim 14, wherein the monitoring report is one of received by the UE as a downlink medium access control (MAC) control element (MAC-CE) or as a downlink control information (DCI) signal, or transmitted by the UE as an uplink MAC-CE or as an uplink control information (UCI) signal.

16. The UE of claim 14, wherein:
the evaluation phase comprises a comparison of a first performance of a first AI model with a second performance of a baseline AI model, the comparison based at least in part on the set of performance monitoring parameters; and
the second performance of the baseline AI model corresponds to at least one of a performance of a second AI model, the first performance of the first AI model at a prior time interval compared with another time interval of the first performance of the first AI model, or a fixed set or a pre-configured set of performance monitoring parameter values.

17. The UE of claim 13, wherein:
the monitoring output phase comprises at least one of a recommended AI model selection indication provided by the UE, or an AI model selection command provided by the network entity; and
the recommended AI model selection indication is at least one of an identifier (ID) of the AI model, a set of label values corresponding to a training dataset corresponding to a trained AI model, a transmission configuration indicator (TCI) state, correlation information, or a quasi-co-location (QCL) relationship.

18. A processor for wireless communication, comprising:
at least one controller coupled with at least one memory and configured to cause the processor to:
receive, from a network entity, an artificial intelligence (AI)-based configuration corresponding to at least one of signal transmission or signal reception, the AI-based configuration associated with one or more AI models, an AI model associated with a dataset;
receive, from the network entity, a reference signal configuration for a set of reference signals, the reference signal configuration paired with the AI-based configuration;
measure a set of report parameters based at least in part on the set of reference signals; and
transmit, to the network entity, a feedback report comprising the set of report parameters, the feedback report usable by the network entity to select the AI model from the one or more AI models.

19. A method performed by a user equipment (UE), the method comprising:
receiving, from a network entity, an artificial intelligence (AI)-based configuration corresponding to at least one of signal transmission or signal reception by the UE, the AI-based configuration associated with one or more AI models, an AI model associated with a dataset;
receiving, from the network entity, a reference signal configuration for a set of reference signals, the reference signal configuration paired with the AI-based configuration;
measuring a set of report parameters based at least in part on the set of reference signals; and
transmitting, to the network entity, a feedback report comprising the set of report parameters, the feedback report usable by the network entity to select the AI model from the one or more AI models.

20. A network entity NE for wireless communication, comprising:
at least one memory; and
at least one processor coupled with the at least one memory and configured to cause the network entity to:
transmit, to a user equipment (UE), an artificial intelligence (AI)-based configuration corresponding to at least one of signal transmission or signal reception by the UE, the AI-based configuration associated with one or more AI models, an AI model associated with a dataset;
transmit, to the UE, a reference signal configuration for a set of reference signals, the reference signal configuration paired with the AI-based configuration;
receive, from the UE, a feedback report comprising a set of report parameters; and
select the AI model based at least in part on the set of report parameters.
